(19) United States
(12) Patent Application Publication
(10) Pub. No.: US 2009/0052715 A1
(43) Pub. Date: Feb. 26, 2009

(54) ELECTRONIC DEVICE WITH AN INTERNAL MICROPHONE ARRAY

(75) Inventors: Bo Zhang, Nanjing (CN); Jie Yu, Nanjing (CN); Ming Zhang, Cupertino, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/843,694

(22) Filed: Aug. 23, 2007

(51) Int. Cl. H04R 17/02; H04R 3/00

(52) U.S. Cl. 381/365; 381/92

(57) ABSTRACT

An electronic device includes a front cover, a circuit board, a plurality of flexible holders, and a plurality of microphones. The front cover includes a plurality of wall portions, a plurality of storage spaces encircled by the wall portions, and a plurality of acoustic openings connecting to the storage spaces. The flexible holders have hollow bodies squeezed into the storage spaces. The microphones are electrically connected to the circuit board and squeezed into the hollow bodies of the flexible holders.

### BACKGROUND OF THE INVENTION

1. Field of the Invention

The invention relates to an electronic device, and more particularly to an electronic device with an internal microphone array.

2. Description of the Related Art

A microphone array is capable of clearly receiving sound from a particular direction while avoiding surrounding noise, and is often applied in high-quality audio recorders or communications devices.

A typical microphone array includes a number of microphones disposed in tandem. Referring to FIG. 1, a simple example is shown wherein the microphone array 10 includes two microphones 11 and 12 placed side by side. Directivities of the microphone array 10 can be achieved by manipulating the signal received by the two microphones 11 and 12. Assuming the two microphones 11 and 12 are omni-directional and have the same characteristics, the directivity of the microphone array 10 depends on the distance D1 between the two microphones 11 and 12.

The disclosed microphones 11 and 12 are placed in an open space for achieving directivity. Most electronic devices (cellular phones, personal digital assistants, notebook computer, etc.), however, have plastic or metal housings, which are acoustic isolators. Acoustic isolators block audio signals increasing difficulty with microphone placement. Specifically, microphone array performance, acceptable in an open space, deteriorates when disposed in a housing of an electronic device, because reception of external sound is hindered by the housing. Also, sound leakage and cross talk between the microphones need to be avoided when the microphone array is disposed in the housing of an electronic device.

### BRIEF SUMMARY OF THE INVENTION

The invention provides an electronic device comprising an internal microphone array capable of adequate performance.

The electronic device in accordance with an exemplary embodiment of the invention includes a front cover, a circuit board, a flexible holder, and a plurality of microphones. The front cover comprises a plurality of wall portions, a plurality of storage spaces encircled by the wall portions, and a plurality of acoustic openings connecting to the storage spaces. The flexible holder comprises a plurality of hollow bodies squeezed into the storage spaces, and a base connecting the hollow bodies. The microphones are electrically connected to the circuit board and squeezed into the hollow bodies of the flexible holder.

The above-mentioned electronic device can be modified in various ways. In another exemplary embodiment of the invention, for example, the hollow bodies have top holes connected to the acoustic openings of the front cover. The diameter of the top holes exceeds that of the acoustic openings to form cavities between the front cover, the flexible holder, and the microphones.

In another exemplary embodiment of the invention, for another example, the electronic device further includes a foam disposed in the cavities.

In another exemplary embodiment of the invention, the base of the flexible holder is held between the circuit board and the wall portions of the front cover.

In another exemplary embodiment of the invention, the hollow bodies have bottom holes through which the microphones are mounted on the circuit board.

In another exemplary embodiment of the invention, the microphones are mounted on the circuit board by surface-mount technology.

In another exemplary embodiment of the invention, the electronic device includes a front cover, a circuit board, a plurality of flexible holders, and a plurality of microphones. The front cover includes a plurality of wall portions, a plurality of storage spaces encircled by the wall portions, and a plurality of acoustic openings connecting to the storage spaces. The flexible holders have hollow bodies squeezed into the storage spaces. The microphones are electrically connected to the circuit board and squeezed into the hollow bodies of the flexible holders.

In another exemplary embodiment of the invention, the hollow bodies have top holes connected to the acoustic openings.

In another exemplary embodiment of the invention, the diameter of the top holes exceeds that of the acoustic openings to form cavities between the front cover, the flexible holders, and the microphones

In another exemplary embodiment of the invention, the electronic device further includes foam disposed in the cavities.

In another exemplary embodiment of the invention, the diameter of the top holes substantially equals that of the acoustic openings.

In another exemplary embodiment of the invention, the hollow bodies have bottom holes. The microphones comprise terminal pins passing through the bottom holes and electrically connecting to the circuit board

In another exemplary embodiment of the invention, the hollow bodies have bottom holes through which the microphones are mounted on the circuit board

In another exemplary embodiment of the invention, the microphones are mounted on the circuit board by surface-mount technology

In another exemplary embodiment of the invention, the wall portions of the front cover contact the circuit board.

In another exemplary embodiment of the invention, the wall portions of the front cover are spaced apart from the circuit board.

In another exemplary embodiment of the invention, the flexible rubber is made of rubber.

In another exemplary embodiment of the invention, the microphones comprise two omni-directional microphones.

In another exemplary embodiment of the invention, the microphones constitute a microphone array.

The electronic device of the invention may be a notebook computer, a cellular phone, a personal digital assistant (PDA), a global positioning system (GPS) receiver, a liquid crystal display (LCD), a speakerphone, or others.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a typical microphone array including two microphones placed side by side;

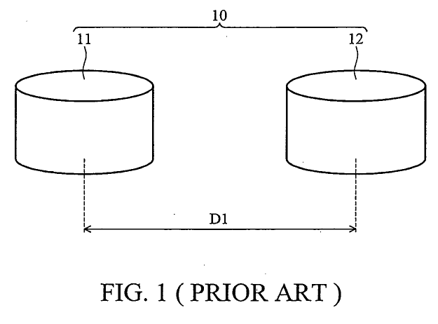

FIG. 2A is a schematic diagram showing an electronic device with an internal microphone array in accordance with a first embodiment of the invention;

FIG. 2B is a sectional diagram of the electronic device of FIG. 2A along line IIB-IIB;

FIG. 2C is a sectional diagram of a front cover of the electronic device of FIG. 2B;

FIG. 2D is a sectional diagram of a flexible holder of the electronic device of FIG. 2B;

FIG. 3A is a sectional diagram of an electronic device in accordance with a second embodiment of the invention;

FIG. 3B is a sectional diagram of a front cover of the electronic device of FIG. 3A;

FIG. 3C is a sectional diagram of a flexible holder of the electronic device of FIG. 3A;

FIG. 4A is a sectional diagram of an electronic device in accordance with a third embodiment of the invention;

FIG. 4B is a sectional diagram of a front cover of the electronic device of FIG. 4A;

FIG. 4C is a sectional diagram of a flexible holder of the electronic device of FIG. 4A;

FIG. 5A is a sectional diagram of an electronic device in accordance with a fourth embodiment of the invention;

FIG. 5B is a sectional diagram of a front cover of the electronic device of FIG. 5A;

FIG. 5C is a sectional diagram of a flexible holder of the electronic device of FIG. 5A;

FIG. 6A is a sectional diagram of an electronic device in accordance with a fifth embodiment of the invention;

FIG. 6B is a sectional diagram of a front cover of the electronic device of FIG. 6A; and

FIG. 6C is a sectional diagram of a flexible holder of the electronic device of FIG. 6A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

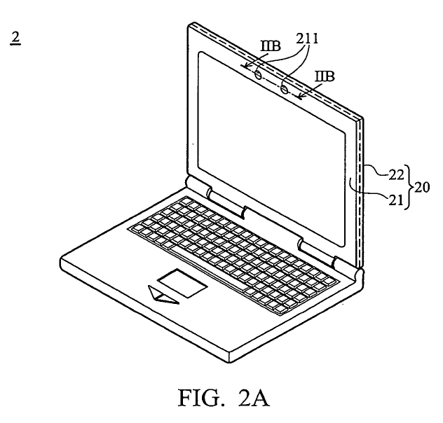

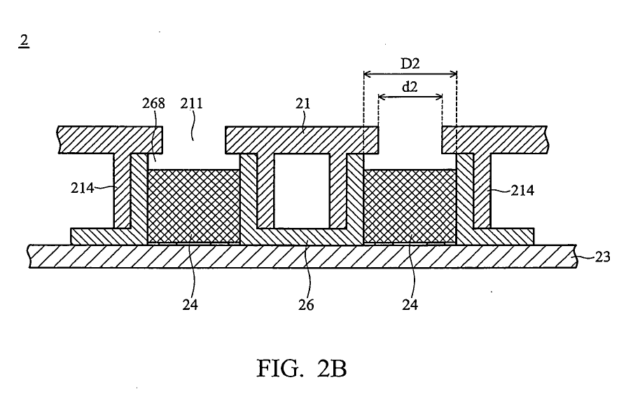

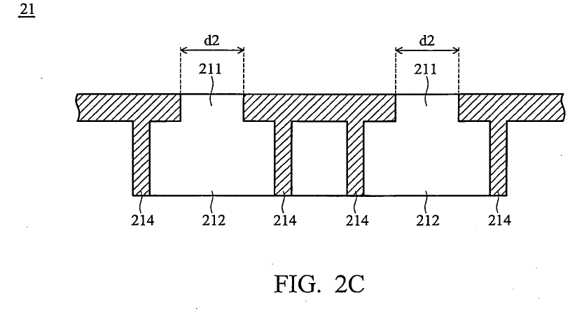

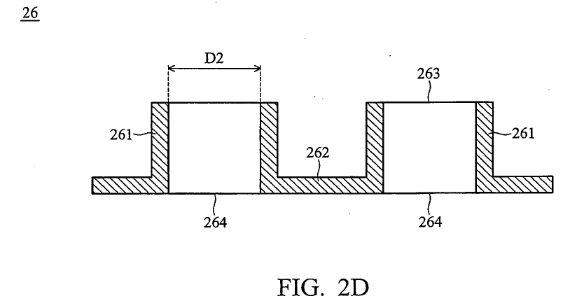

Referring to FIG. 2A, an electronic device in a first embodiment of the invention is a notebook computer 2. The notebook computer 2 has a housing 20. The housing 20 has a front cover 21 and a rear cover 22, wherein a plurality of acoustic openings 211 are provided in the front cover 21 allowing external sound to enter.

FIG. 2B is a sectional view of the notebook computer along line IIB-IIB, wherein a circuit board 23, a flexible holder 26, and a plurality of microphones 24 are provided in the housing 20 of the notebook computer 2.

Referring to FIG. 2C, the front cover 21 has a plurality of wall portions 214 protruding inward to form a plurality of storage spaces 212. That is, the storage spaces 212 are encircled by the wall portions 214. Furthermore, the storage spaces 212 are connected to the acoustic openings 211 of the front cover 21. Each of the acoustic openings 211 is d2 in diameter.

Referring to FIG. 2D, the flexible holder 26 has a base 262 and a plurality of hollow bodies 261 protruding from base 262. Each of the hollow bodies 261 has a top hole 263 and a bottom hole 264. The diameter D2 of the top hole 263 exceeds the diameter d2 of the acoustic opening 211. In the first embodiment, the flexible holder 26 is made of rubber.

Referring to FIG. 2B, the microphones 24 are mounted on the circuit board 23 by, for example, surface-mount technology (SMT). During assembly, the microphones 24 are squeezed into the hollow bodies 261 of the flexible holder 26 through the bottom holes 264. Then, the hollow bodies 261 of the flexible holder 26 are squeezed into the storage spaces 212 of the front cover 21, wherein the top holes 263 of the bodies 261 of the flexible holder 26 are connected to the acoustic openings 211 of the front cover 21, and the base 262 of the flexible holder 26 is tightly held between the circuit board 23 and the wall portions 214 of the front cover 21.

As described, the diameter D2 of the top hole 263 of the flexible holder 26 exceeds the diameter d2 of the acoustic opening 211 of the front cover 21. Thus, a cavity 268 is formed between the front cover 21, the flexible holder 26, and the microphone 24. The cavity 268 is as small as possible, for reducing the size of the flexible holder 26 to a minimum, saving space in the notebook computer 2, and maintaining good performance of the microphones 24.

In the first embodiment, all of the microphones 24 are omni-directional. In operation, the omni-directional microphones 24 constitute a microphone array to receive external sound via the acoustic openings 211 of the front cover 21. The directivity of the microphone array is determined by the distance between the acoustic openings 211.

The flexible holder 26 not only protects the internal omni-directional microphones 24 from vibrations but also avoids sound leakage. The omni-directional microphones 24 are enclosed by the circuit board 23 and the flexible holder 26, both of which are acoustic isolators. Thus, the omni-directional microphones 24 in the flexible holder 26 merely receive external sound via the acoustic openings 211 of the front cover 21 of the notebook computer 2.

While a notebook computer is utilized for purposes of illustration, it is understood that the invention is equally applicable to a variety of electronic devices including cellular phones, personal digital assistants (PDAs), global positioning system (GPS) receivers, liquid crystal displays (LCDs), speakerphones, and others.

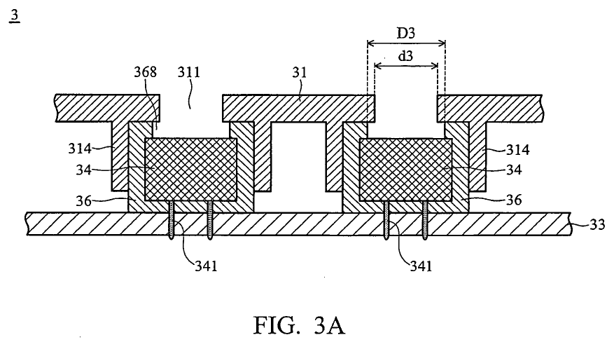

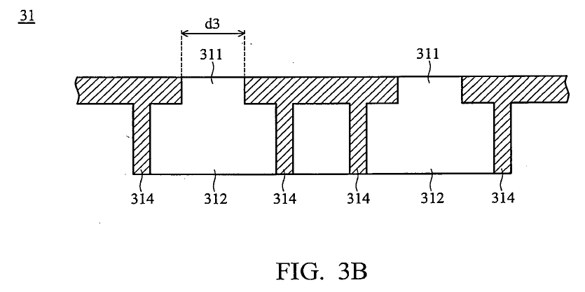

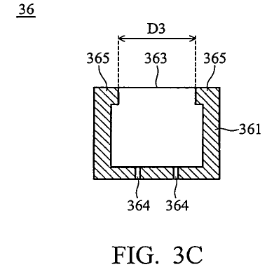

Referring to FIG. 3A, an electronic device 3 in a second embodiment of the invention has a front cover 31. A plurality of acoustic openings 311 are provided in the front cover 31 allowing external sound to enter. Furthermore, a circuit board 33, a plurality of flexible holders 36, and a plurality of microphones 34 are provided behind the front cover 31 of the electronic device 3.

Referring to FIG. 3B, the front cover 31 has a plurality of wall portions 314 protruding inward to form a plurality of storage spaces 312. That is, the storage spaces 312 are encircled by the wall portions 314. Furthermore, the storage spaces 312 are connected to the acoustic openings 311 of the front cover 31. Each of the acoustic openings 311 is d3 in diameter.

Referring to FIG. 3C, each of the flexible holders 36 has a hollow body 361. The hollow body 361 has a top hole 363, top flanges 365 disposed around the top hole 363, and a plurality of bottom holes 364. The diameter D3 of the top hole 363 exceeds the diameter d3 of the acoustic opening 311. In the second embodiment, the flexible holder 36 is made of rubber.

Referring to FIG. 3A, the microphones 34 have terminal pins 341 passing through the bottom holes 364 of the flexible holders 34 and electrically connecting to the circuit board 33. During assembly, the microphones 34 are squeezed into the hollow bodies 361 of the flexible holders 36. Then, the hollow bodies 361 of the flexible holders 36 are squeezed into the storage spaces 312 of the front cover 31, wherein the top holes 363 of the bodies 361 of the flexible holder 36 are connected to the acoustic openings 311 of the front cover 31, and the circuit board 23 does not contact the wall portions 314 of the front cover 31.

As described, the diameter D3 of the top hole 363 of the flexible holder 36 exceeds the diameter d3 of the acoustic opening 311 of the front cover 31. Thus, a cavity 368 is formed between the front cover 31, the flexible holder 36, and the microphone 34. The cavity 368 is as small as possible, for reducing the size of the flexible holder 36 to a minimum, saving space in the electronic device 3, and maintaining good performance of the microphones 34.

In the second embodiment, all of the microphones 34 are omni-directional. In operation, the omni-directional microphones 34 constitute a microphone array to receive external sound via the acoustic openings 311 of the front cover 31. The directivity of the microphone array is determined by the distance between the acoustic openings 311.

The flexible holders 36 not only protect the internal omni-directional microphones 34 from vibrations but also avoid sound leakage. The omni-directional microphones 34 are enclosed by the flexible holders 36 which are acoustic isolators. Thus, the omni-directional microphones 34 in the flexible holders 36 merely receive external sound via the acoustic openings 311 of the front cover 31 of the electronic device 3.

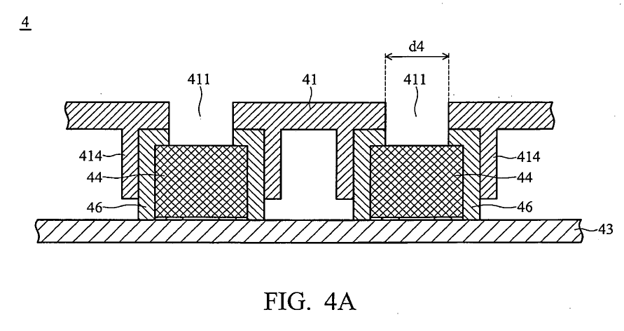

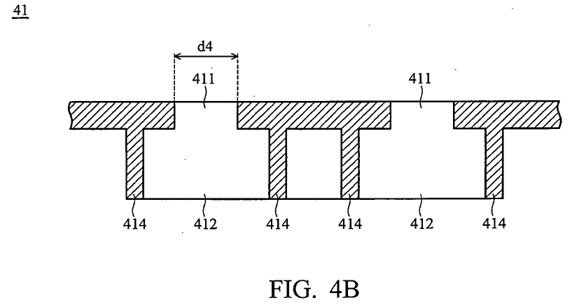

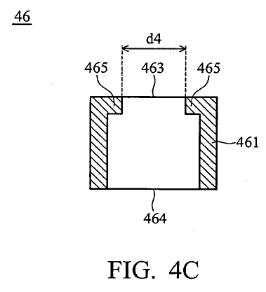

Referring to FIG. 4A, an electronic device 4 in a third embodiment of the invention has a front cover 41. A plurality of acoustic openings 411 are provided in the front cover 41 allowing external sound to enter. Furthermore, a circuit board 43, a plurality of flexible holders 46, and a plurality of microphones 44 are provided behind the front cover 41 of the electronic device 4.

Referring to FIG. 4B, the front cover 41 has a plurality of wall portions 414 protruding inward to form a plurality of storage spaces 412. That is, the storage spaces 412 are encircled by the wall portions 414. Furthermore, the storage spaces 412 are connected to the acoustic openings 411 of the front cover 41. Each of the acoustic openings 411 is d4 in diameter.

Referring to FIG. 4C, each of the flexible holders 46 has a hollow body 461. The hollow body 461 has a top hole 463, top flanges 465 disposed around the top hole 463, and a bottom hole 464. The diameter d4 of the top hole 463 substantially equals that of the acoustic opening 411. In the third embodiment, the flexible holder 46 is made of rubber.

Referring to FIG. 4A, the microphones 44 are mounted on the circuit board 43 by, for example, surface-mount technology (SMT). During assembly, the microphones 44 are squeezed into the hollow bodies 461 of the flexible holders 46 through the bottom holes 464. Then, the hollow bodies 461 of the flexible holders 46 are squeezed into the storage spaces 412 of the front cover 41, wherein the top holes 463 of the bodies 461 of the flexible holder 46 are connected to the acoustic openings 411 of the front cover 41, and the circuit board 43 does not contact the wall portions 414 of the front cover 41.

In the third embodiment, all of the microphones 44 are omni-directional. In operation, the omni-directional microphones 44 constitute a microphone array to receive external sound via the acoustic openings 411 of the front cover 41. The directivity of the microphone array is determined by the distance between the acoustic openings 411.

The flexible holders 46 not only protect the internal omni-directional microphones 44 from vibrations but also avoid sound leakage. The omni-directional microphones 44 are enclosed by the flexible holders 46 and the circuit board 43, both of which are acoustic isolators. Thus, the omni-directional microphones 44 in the flexible holders 46 merely receive external sound via the acoustic openings 411 of the front cover 41 of the electronic device 4.

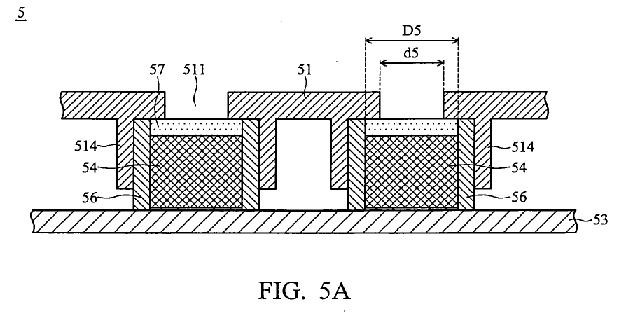

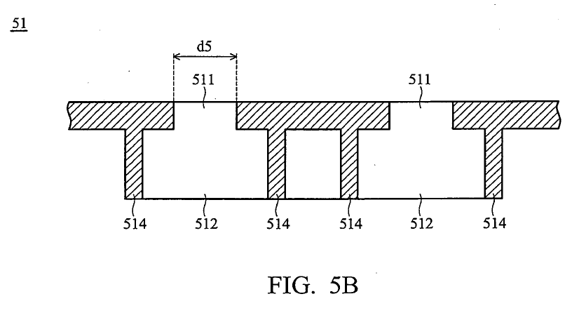

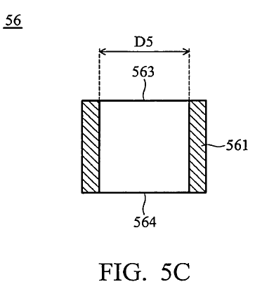

Referring to FIG. 5A, an electronic device 5 in a fourth embodiment of the invention has a front cover 51. A plurality of acoustic openings 511 are provided in the front cover 51 allowing external sound to enter. Furthermore, a circuit board 53, a plurality of flexible holders 56, and a plurality of microphones 54 are provided behind the front cover 51 of the electronic device 5.

Referring to FIG. 5B, the front cover 51 has a plurality of wall portions 514 protruding inward to form a plurality of storage spaces 512. That is, the storage spaces 512 are encircled by the wall portions 514. Furthermore, the storage spaces 512 are connected to the acoustic openings 511 of the front cover 51. Each of the acoustic openings 511 has a diameter of d5.

Referring to FIG. 5C, each of the flexible holders 56 has a hollow body 561. The hollow body 561 has a top hole 563 and a bottom hole 564. The diameter D5 of the top hole 563 exceeds the diameter d5 of the acoustic opening 511. In the fourth embodiment, the flexible holder 56 is made of rubber.

Referring to FIG. 5A, the microphones 54 are mounted on the circuit board 53 by, for example, surface-mount technology (SMT). During assembly, the microphones 54 are squeezed into the hollow bodies 561 of the flexible holders 56 through the bottom holes 564. Then, the hollow bodies 561 of the flexible holders 56 are squeezed into the storage spaces 512 of the front cover 51, wherein the circuit board 53 does not contact the wall portions 514 of the front cover 51.

As described, the diameter D5 of the top hole 563 of the flexible holder 56 exceeds the diameter d5 of the acoustic opening 511 of the front cover 51. Thus, a cavity is formed between the front cover 51, the flexible holder 56, and the microphone 54. The cavity is as small as possible, for reducing the size of the flexible holder 56 to a minimum, saving space in the electronic device 5, and maintaining good performance of the microphones 54. A foam 57 is disposed in the cavity to avoid reception of wind sound and entry of dust.

In the fourth embodiment, all of the microphones 54 are omni-directional. In operation, the omni-directional microphones 54 constitute a microphone array to receive external sound via the acoustic openings 511 of the front cover 51. The directivity of the microphone array is determined by the distance between the acoustic openings 511.

The flexible holders 56 not only protect the internal omni-directional microphones 54 from vibrations but also avoid sound leakage. The omni-directional microphones 54 are enclosed by the flexible holders 56 and the circuit board 53, both of which are acoustic isolators. Thus, the omni-directional microphones 54 in the flexible holders 56 merely receive external sound via the acoustic openings 511 of the front cover 51 of the electronic device 5.

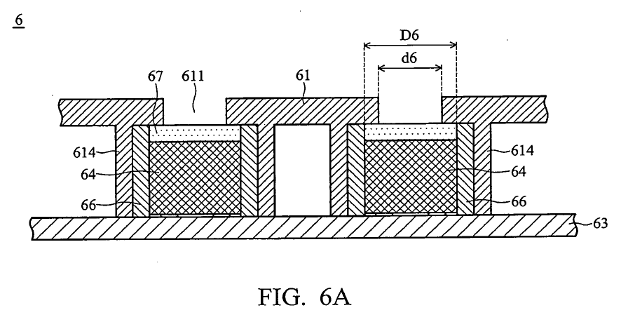

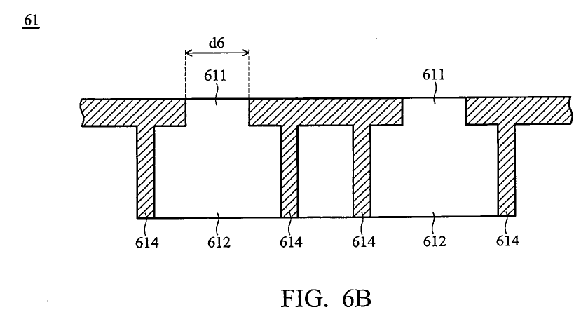

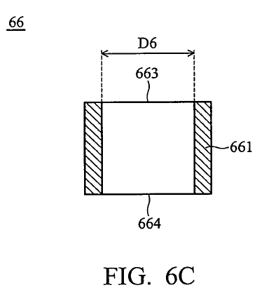

Referring to FIG. 6A, an electronic device 6 in a fifth embodiment of the invention has a front cover 61. A plurality of acoustic openings 611 are provided in the front cover 61 allowing external sound to enter. Furthermore, a circuit board 63, a plurality of flexible holders 66, and a plurality of microphones 64 are provided behind the front cover 61 of the electronic device 6.

Referring to FIG. 6B, the front cover 61 has a plurality of wall portions 614 protruding inward to form a plurality of storage spaces 612. That is, the storage spaces 612 are encircled by the wall portions 614. Furthermore, the storage spaces 612 are connected to the acoustic openings 611 of the front cover 61. Each of the acoustic openings 611 has a diameter of d6.

Referring to FIG. 6C, each of the flexible holders 66 has a hollow body 661. The hollow body 661 has a top hole 663 and a bottom hole 664. The diameter D6 of the top hole 663 exceeds the diameter d6 of the acoustic opening 611. In the fifth embodiment, the flexible holder 66 is made of rubber.

Referring to FIG. 6A, the microphones 64 are mounted on the circuit board 63 by, for example, surface-mount technology (SMT). During assembly, the microphones 64 are squeezed into the hollow bodies 661 of the flexible holders 66 through the bottom holes 664. Then, the hollow bodies 661 of the flexible holders 66 are squeezed into the storage spaces 612 of the front cover 61. The hollow bodies 661 of the flexible holders 66 are advanced until the circuit board 63 contacts the wall portions 614 of the front cover 61. Then, the circuit board 63 is pushed toward the front cover 61 so that the flexible holders 66 can be further squeezed and contracted. This can effectively enhance an airtight fit between the flexible holders 66 and the front cover 61.

As described, the diameter D6 of the top hole 663 of the flexible holder 66 exceeds the diameter d6 of the acoustic opening 611 of the front cover 61. Thus, a cavity is formed between the front cover 61, the flexible holder 66, and the microphone 64. The cavity is as small as possible, for reducing the size of the flexible holder 66 to a minimum, saving space in the electronic device 6, and maintaining good performance of the microphones 64. A foam 67 is disposed in the cavity to avoid reception of wind sound and entry of dust.

In the fifth embodiment, all of the microphones 64 are omni-directional. In operation, the omni-directional microphones 64 constitute a microphone array to receive external sound via the acoustic openings 611 of the front cover 61. The directivity of the microphone array is determined by the distance between the acoustic openings 611.

The flexible holders 66 not only protect the internal omni-directional microphones 64 from vibrations but also avoid sound leakage. The omni-directional microphones 64 are enclosed by the flexible holders 66 and the circuit board 63, both of which are acoustic isolators. Thus, the omni-directional microphones 64 in the flexible holders 66 merely receive external sound via the acoustic openings 611 of the front cover 61 of the electronic device 6.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a front cover comprising a plurality of wall portions, a plurality of storage spaces encircled by the wall portions, and a plurality of acoustic openings connecting to the storage spaces;
a circuit board;
a flexible holder comprising a plurality of hollow bodies squeezed into the storage spaces, and a base connecting the hollow bodies; and
a plurality of microphones electrically connected to the circuit board and squeezed into the hollow bodies of the flexible holder.

2. The electronic device as claimed in claim 1, wherein the hollow bodies have top holes connected to the acoustic openings of the front cover.

3. The electronic device as claimed in claim 2, wherein the diameter of the top holes exceeds that of the acoustic openings to form cavities between the front cover, the flexible holder, and the microphones.

4. The electronic device as claimed in claim 3, further comprising foam which is disposed in the cavities.

5. The electronic device as claimed in claim 1, wherein the base of the flexible holder is held between the circuit board and the wall portions of the front cover.

6. The electronic device as claimed in claim 1, wherein the hollow bodies have bottom holes through which the microphones are mounted on the circuit board.

7. The electronic device as claimed in claim 6, wherein the microphones are mounted on the circuit board by surface-mount technology.

8. The electronic device as claimed in claim 1, wherein the flexible rubber is made of rubber.

9. The electronic device as claimed in claim 1, wherein the microphones comprise two omni-directional microphones.

10. The electronic device as claimed in claim 1, wherein the microphones constitute a microphone array.

11. The electronic device as claimed in claim 1, wherein the electronic device is a notebook computer.

12. The electronic device as claimed in claim 1, wherein the electronic device is a cellular phone.

13. The electronic device as claimed in claim 1, wherein the electronic device is a personal digital assistant.

14. The electronic device as claimed in claim 1, wherein the electronic device is a global positioning system receiver.

15. The electronic device as claimed in claim 1, wherein the electronic device is a liquid crystal display.

16. The electronic device as claimed in claim 1, wherein the electronic device is a speakerphone.

17. An electronic device, comprising:
a front cover comprising a plurality of wall portions, a plurality of storage spaces encircled by the wall portions, and a plurality of acoustic openings connecting to the storage spaces;
a circuit board;
a plurality of flexible holders comprising hollow bodies squeezed into the storage spaces; and
a plurality of microphones electrically connected to the circuit board and squeezed into the hollow bodies of the flexible holders.

18. The electronic device as claimed in claim 17, wherein the hollow bodies have top holes connected to the acoustic openings.

19. The electronic device as claimed in claim 18, wherein the diameter of the top holes exceeds that of the acoustic openings to form cavities between the front cover, the flexible holders, and the microphones.

20. The electronic device as claimed in claim 19, further comprising foam which is disposed in the cavities.

21. The electronic device as claimed in claim 18, wherein the diameter of the top holes substantially equals that of the acoustic openings.

22. The electronic device as claimed in claim 17, wherein the hollow bodies have bottom holes, and the microphones comprise terminal pins passing through the bottom holes and electrically connecting to the circuit board.

23. The electronic device as claimed in claim 17, wherein the hollow bodies have bottom holes through which the microphones are mounted on the circuit board.

24. The electronic device as claimed in claim 23, wherein the microphones are mounted on the circuit board by surface-mount technology.

25. The electronic device as claimed in claim 17, wherein the wall portions of the front cover contact the circuit board.

26. The electronic device as claimed in claim 17, wherein the wall portions of the front cover are spaced apart from the circuit board.

27. The electronic device as claimed in claim 17, wherein the flexible rubber is made of rubber.

28. The electronic device as claimed in claim 17, wherein the microphones comprise two omni-directional microphones.

29. The electronic device as claimed in claim 17, wherein the microphones constitute a microphone array.

30. The electronic device as claimed in claim 17, wherein the electronic device is a notebook computer.

31. The electronic device as claimed in claim 17, wherein the electronic device is a cellular phone.

32. The electronic device as claimed in claim 17, wherein the electronic device is a personal digital assistant.

33. The electronic device as claimed in claim 17, wherein the electronic device is a global positioning system receiver.

34. The electronic device as claimed in claim 17, wherein the electronic device is a liquid crystal display.

35. The electronic device as claimed in claim 17, wherein the electronic device is a speakerphone.
